(19) United States
(12) Patent Application Publication
(10) Pub. No.: US 2022/0056755 A1
(43) Pub. Date: Feb. 24, 2022

(54) TRAFFIC DOOR WITH EDGE TRIM AND METHOD OF ASSEMBLING SAME

(71) Applicant: Phoenix Door Systems LLC, Mason, OH (US)

(72) Inventor: Robert J. Clark, Cincinnati, OH (US)

(21) Appl. No.: 17/407,317

(22) Filed: Aug. 20, 2021

Related U.S. Application Data
(60) Provisional application No. 63/069,425, filed on Aug. 24, 2020.

(51) Int. Cl. E06B 3/88; E06B 7/28

(52) U.S. Cl. CPC E06B 3/88; E05Y 2900/132; E06B 7/28

(57) ABSTRACT

A traffic door includes a door body having at least one edge and opposed faces, and an edge trim including an inner surface and an outer surface and attached to the door body to cover at least a portion of the at least one edge. The inner surface of the edge trim includes a cavity that receives the at least one edge of the door body therein and the edge trim is secured to the door body through a friction fit between the cavity and the door body. The edge trim includes reinforcement regions adjacent the cavity to increase strength in this region, and void regions away from the cavity to minimizing weight and material usage. A method of assembling a traffic door having edge trim is also disclosed.

### CROSS-REFERENCE TO RELATED APPLICATION

This application claims the benefit of and priority to U.S. Provisional Application No. 63/069,425 filed Aug. 24, 2020 (pending), the disclosure of which is incorporated by reference herein in its entirety.

### TECHNICAL FIELD

This disclosure relates generally to traffic doors, and more particularly to a traffic door with edge trim, a method of making the edge trim, and a method of assembling a traffic door with the edge trim.

### BACKGROUND

Traffic doors are two-way swinging doors commonly used in industrial and commercial settings to provide access between different portions of a facility. The doors are generally biased to a closed position and can be moved to an opened position manually or by impact with material handling equipment, such as forklift trucks, hand trucks, shopping carts, etc. As such, traffic doors have to be designed with sufficient strength and resiliency to withstand repeated impacts during operation.

FIG. 1 illustrates a traffic door 10 in accordance with the prior art. Many traffic doors 10 have a construction that includes a generally rectangular door body 12 having an upper edge 14, a lower edge 16, a leading edge 18 and a trailing edge 20 that generally define opposing faces 22 of the traffic door 10. The trailing edge 20 of the traffic door 10 typically includes a hinge mechanism with upper and lower hinge elements 24, 26 at which the traffic door 10 pivotally couples to a door jamb (not shown). The door body 12 is typically formed from sheet metal in a conventional construction and the leading and/or trailing edges 18, 20 of the traffic door 10 include an edge profile 28 to prevent the sharp, unfinished edge 30 of the door body 12 from exposure to operators of the traffic door 10. In a conventional construction, for example, the material at the leading and/or the trailing edges 18, 20 of door body 12 may be bent back onto itself such that the sharp edge 30 overlaps with and confronts a portion of the door body 12. In this way, the sharp edge 30 is located away from the outermost extent of the traffic door 10 at the leading and/or trailing edges 18, 20.

By way of example, FIGS. 1-3 illustrate typical ways that a leading and/or trailing edge 18, 20 of a traffic door 10 may be bent to form an edge profile 28. More particularly, FIG. 1 shows a delta-shape edge profile 28. FIGS. 2 and 3 alternatively show diamond-shape edge profiles 28. In each of these profiles, the sharp, unfinished edge 30 of the door body 12 is folded back against the door body 12 and a smoother, formed aspect of the edge profile 28 (e.g., one of the vertices of the delta- or diamond-shaped edge profiles 28) may be exposed at the lateral extents of the traffic door 10. In this manner, an operator is at least partially shielded from coming into contact with the sharp, unfinished edge 30 of the door body 12 by virtue of the edge profile 28 at the bent leading and/or trailing edges 18, 20.

While traffic doors as described above are generally successful for their intended purpose and operation, conventional traffic doors have some deficiencies which manufacturers continually strive to improve upon. For example, manufacturers continually strive to improve safety aspects of traffic doors. In this regard, because traffic doors are designed to absorb repeated impacts from material handling equipment, such as along the leading edge of the traffic door, it is desirable that the traffic door be constructed to endure such impacts over the operating life of the traffic door. It is common during use, however, that operators of material handling equipment ignore operating guidelines and impact the doors with higher-than-expected forces. In some instances, these impacts start deforming the traffic door, especially along the edge profile at the leading edge of the door. As the traffic door continues to absorb impacts, the leading edge may continue to be deformed to the point that the sharp, unfinished edge of the door body comes away from the door body to be exposed. This results in potentially unsafe conditions for operators who interact with the traffic door.

Additionally, conventional traffic doors suffer from certain manufacturing inefficiencies that increase costs of traffic doors. More particularly, providing an edge profile by bending the material of the door body adjacent its leading and/or trailing edges is inefficient and costly. Not only does this introduce an extra processing step for forming the door body, but in order to quickly fill orders, it also mandates that a manufacturer maintain a large inventory of manufactured traffic doors (i.e., having the edge profile already formed therein) of various predetermined widths. This is because once the edge profile is formed in the material at the leading and trailing edges, the width of the traffic door may not be altered, such as being cut to an alternative width. The large amount of inventory maintained by a manufacturer requires considerable warehouse space and associated upkeep, which in turn increases the overall cost of the traffic doors. Additionally, should an order come in for a traffic door having an unconventional width, i.e., one that is not of a standard width normally held in inventory, the traffic door has to be custom made. Custom made traffic doors, however, are expensive to manufacture. Furthermore, custom made traffic doors take an increased amount of time to manufacture with the consequence that the installation of the traffic door in a facility may be significantly delayed.

Accordingly, there is a need for a traffic door having an improved edge profile construction that accommodates and endures repeated impacts from operators and material handling equipment without significant deformation. There is also a need for a method of making a traffic door that is more efficient and robust as compared to the manufacturing methods of current traffic doors.

### SUMMARY

To address these and other deficiencies, a traffic door includes a door body having at least one edge and opposed faces, and an edge trim including an inner surface and an outer surface and attached to the door body so as to cover at least a portion of the at least one edge. The inner surface of the edge trim includes a cavity that receives the at least one edge of the door body therein and the edge trim is secured to the door body through a friction fit between the cavity and the door body. In one embodiment, the door body is generally rectangular and includes a leading edge and a trailing edge, and the edge trim is attached to the door body so as to cover at least a portion of the leading edge. Additionally, or alternatively, the edge trim is attached to the door body to cover at least a portion of the trailing edge.

In one embodiment, the cavity may include one or more friction-enhancing elements. For example, the cavity may include one or more teeth for facilitating the friction fit between the cavity and the door body. In one embodiment, the cavity may be generally rectangular including a base wall confronting the at least one edge of the door body and a pair of opposed side walls extending from the base wall and confronting the opposed faces of the door body. Each of the side walls may include one or more teeth extending from the side wall. The number of teeth, arrangement of the teeth on the side walls, and shape of the teeth may vary in alternative embodiments. For example, the one or more teeth on the opposing side walls may be aligned or offset from each other along the length of the cavity.

In one aspect of the disclosure, the edge trim includes reinforcement regions adjacent the cavity and void regions away from the cavity. In one embodiment, for example, the door body has a thickness and the edge trim has a wall thickness along the cavity, wherein the wall thickness of the edge trim may be greater than the thickness of the door body for at least 50% of the length of the cavity. Alternatively, the wall thickness of the edge trim may be greater than the thickness of the door body for at least 75% of the length of the cavity. Still further, the wall thickness of the edge trim may be greater than the thickness of the door body for at least 90% of the length of the cavity. The reinforcing regions aid in preventing deformations in the edge trim adjacent the at least one edge of the door body and the void regions aid in reducing weight and material costs.

In an exemplary embodiment, the edge trim includes a generally oval cross-sectional profile devoid of sharp edges adjacent the at least one edge of the door body. By way of example, the edge trim may include a spine having an inner surface and an outer surface, the inner surface of the spine including the cavity, and a pair of arms extending from opposed sides of the spine and overlying respective faces of the door body. Each of the arms may be arcuate and the arms converge toward each other in a direction away from the spine. Additionally, distal ends of the arms may define a gap that receives the door body therebetween. In one embodiment, each of the arms includes a trim edge at a distal end thereof, and the trim edges engage with a respective face of the door body and are spaced from the at least one edge of the door body. In this way, the trim edges are removed from the region of the traffic door configured to receive impacts during use.

In another embodiment, a method of making a traffic door includes providing a door body having at least one edge and opposed faces; providing an edge trim including an inner surface and an outer surface, wherein the inner surface of the edge trim includes a cavity configured to receive at least a portion of the at least one edge therein; positioning the edge trim relative to the at least one edge of the door body such that the inner surface of the edge trim confronts the at least one edge of the door body; and pressing the edge trim toward the door body so that the at least one edge of the door body is inserted into the cavity to secure the edge trim to the door body through a friction fit between the cavity and the door body.

In one embodiment, providing the door body further includes providing a material blank of a predetermined size and cutting the material blank to provide the door body with a desired size. In one embodiment, pressing the edge trim toward the door body includes engaging the door body with one or more teeth positioned within the cavity to provide the friction fit between the cavity and the door body. In accordance with an aspect of the method, pressing the edge trim toward the door body may be performed manually. Alternatively, the pressing of the edge trim may be done using an automated pressing machine.

In one embodiment, the edge trim includes a spine having an inner surface and an outer surface, the inner surface of the spine including the cavity, and a pair of arms extending from opposed sides of the spine and overlying respective faces of the door body. In this embodiment, pressing the edge trim toward the door body may further include inserting the at least one edge of the door body through a gap defined between a distal end of the arms of the edge trim. The method may further include forming a friction fit between the distal end of the arms and the opposed faces of the door body.

In accordance with an aspect of the disclosure, providing the edge trim may further include forming reinforcing regions in the edge trim adjacent the cavity and forming void regions in the edge trim away from the cavity. In another aspect, the door body includes a leading edge and a trailing edge and positioning the edge trim relative to the at least one edge of the door body further includes positioning the edge trim relative to at least one of the leading or trailing edges of the door body. Preferably, the edge trim may be positioned on both the leading and trailing edges of the door body.

In a further embodiment, an edge trim for attachment to a door body of a traffic door is disclosed. The door body includes an edge and opposed faces and the edge trim is configured to cover at least a portion of the edge of the door body. The edge trim includes a spine having an inner surface and an outer surface, the inner surface including a cavity configured to receive the edge of the door body therein, and a pair of arms extending from opposed sides of the spine and configured to overly respective faces of the door body. The cavity includes a plurality of friction-enhancing elements to effectuate a fiction fit between the edge trim and the door body when coupled together.

In one embodiment, the cavity is generally rectangular and further includes a base wall configured to confront the edge of the door body and a pair of opposed side walls extending from the base wall and configured to confront the opposed faces of the door body. Each of the side walls includes one or more teeth extending from the side wall. The edge trim includes reinforcement regions adjacent the cavity, void regions away from the cavity, and may have a generally oval cross-sectional profile generally devoid of sharp edges along an exposed outer surface thereof. In one embodiment, each of the arms is arcuate and the arms are configured to converge toward each other in a direction away from the spine. A distal end of the arms defines a gap configured to receive the door body therebetween and form a friction fit with the door body.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 illustrates a traffic door with a delta-shaped edge profile generally known in the prior art;

FIG. 2 illustrates an alternative diamond-shaped edge profile generally known in the prior art;

FIG. 3 illustrates a variation of the diamond-shaped edge profile of FIG. 2 generally known in the prior art;

FIG. 4 a front plan view of a traffic door having a trim part according to an embodiment of the present disclosure;

FIG. 5 is a front plan view of a material blank for forming a door body of the traffic door shown in FIG. 4;

FIG. 6 is cross-sectional view of the traffic door of FIG. 4 generally taken along line 6-6;

FIG. 7 is a partial perspective view of a portion of a traffic door illustrated in FIG. 4 showing the edge trim;

FIG. 8 is an enlarged end view of the traffic door of FIG. 7 illustrating the details of the edge trim in accordance with an embodiment of the disclosure;

FIG. 9 is an enlarged end view similar to FIG. 8 illustrating an edge trim in accordance with another embodiment of the disclosure;

FIG. 10 is an enlarged end view similar to FIG. 8 illustrating an edge trim in accordance with another embodiment of the disclosure;

FIG. 11A is a front plan view of a traffic door with edge trim arranged in accordance with another embodiment of the disclosure; and

FIG. 11B is a front plan view of a traffic door with edge trim arranged in accordance with another embodiment of the disclosure.

### DETAILED DESCRIPTION

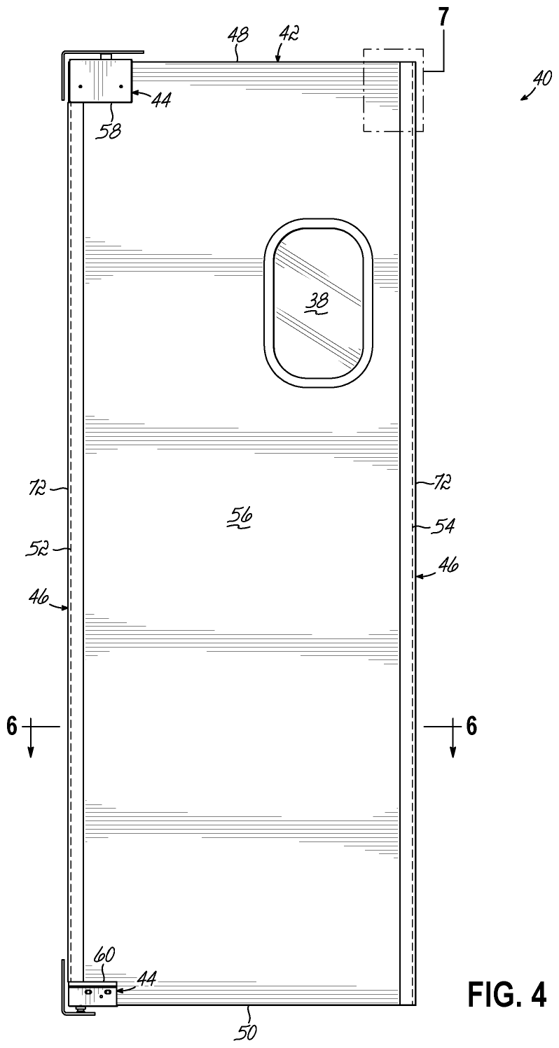

FIG. 4 illustrates an exemplary traffic door 40 in accordance with an embodiment of the invention that overcomes the shortcomings of many of the current traffic doors on the market. More particularly, the traffic door 40 includes a new and improved edge profile in the form of an edge trim, as will be described in more detail below, applied to the leading and/or trailing edges of the traffic door 40 to protect operators from coming into contact with a sharp, unfinished edge of the traffic door. The edge trim is configured as a separate piece or element which is frictionally fit to the desired edge of the door body during manufacturing. Providing the edge trim as a separate element results in a number of manufacturing efficiencies that decrease the overall costs of the traffic door. Moreover, because the edge trim is a separate element, traffic doors of varying sizes may be manufactured in a straight-forward manner without the need for costly and time-consuming custom manufacturing techniques. This allows traffic doors of standard and non-standard sizes to be manufactured, delivered and installed in a cost and time efficient manner.

In a normal operating environment, the traffic door 40 is generally positioned within a doorway at a facility (not shown). The facility may be most any industrial or commercial setting where it is desirable to separate two regions of the facility, such as by a wall or similar barrier, and provide selective access between the two regions via the doorway. The traffic door 40 includes a door body 42, a hinge mechanism 44 for rotatably coupling the traffic door 40 to the doorway, and edge trim 46 coupled to at least a portion of one or more edges of the door body 42 to shield an operator from the sharp, unfinished edge of the door body 42. The door body 42 and the edge trim 46 coupled thereto will be described in more detail below.

In use, the traffic door 40 is configured to be moved from a closed position to an opened position to provide access through the doorway. More particularly, the traffic door 40 is configured to be rotatable in forwards and backwards directions, as is generally known in the art. For example, material handling equipment (not shown), such as various forklift trucks, hand trucks, shopping carts, etc., is configured to contact one of the major faces of the traffic door 40 (i.e., on either side of the door) in order to move the door 40 from the closed position to the opened position. In other words, the impact from the material handling equipment is the motive force that causes the traffic door 40 to move from the closed position to the opened position to thereby allow the material handling equipment to pass through the doorway. The hinge mechanism 44 biases the traffic door 40 toward the closed position such that after the material handling equipment passes through the doorway, the traffic door 40 moves back to the closed position under the bias from the hinge mechanism 44. Additionally, in an exemplary embodiment and as illustrated in FIG. 4, to provide some visibility through the traffic door 40, the door 40 may be provided with a window 38. The traffic door 40 may have other features, such as bumpers (not shown), known to those of ordinary skill in the art.

In an exemplary embodiment of the traffic door 40, the door body 42 includes an upper edge 48, a lower edge 50, a trailing edge 52, and a leading edge 54 that generally define opposing faces 56. As noted above, the trailing edge 52 of the traffic door 40 includes a hinge mechanism 44 that allows the traffic door 40 to pivotally couple to a doorway in a wall or other structure within a facility. For example, in one embodiment, the hinge mechanism 44 may include an upper hinge element 58 and a lower hinge element 60, including various brackets, pins, saddles, axles, etc., all of which are generally known in the art. In its working environment, the upper edge 48 of the traffic door 40 generally confronts the top of a doorway, the lower edge 50 generally confronts the floor of a facility, the trailing edge 52 generally confronts the door jamb of the doorway to which the upper and lower hinge elements 58, 60 are coupled, and the leading edge 54 generally confronts the opposing door jamb of the doorway or another traffic door 40 if traffic doors 40 are being used in pairs.

In an exemplary embodiment, the door body 42 may be formed from a generally rectangular and planar sheet or slab of material. While the door body 42 is preferably rectangular in shape, it should be recognized that the door body 42 may have other shapes, depending on the particular application for the traffic door 40. In one embodiment, for example, the door body 42 may include a generally rectangular piece of sheet metal. Preferably, the door body 42 may have a generally aluminum construction. Alternatively, the door body 42 may be constructed from stainless steel or other suitable metals. In a further alternative embodiment, the door body 42 may be formed from a non-metal, such as a suitable plastic material capable of withstanding the impact on the traffic door 40. By way of example, the door body may be made acrylonitrile butadiene styrene (ABS), fiber reinforced polymers (FRP), or other plastics. Furthermore, the door body 42 may have a wide variety of sizes and thicknesses depending on the particular application of the traffic door 40. By way of example, the door body 42 may be formed from a sheet of material that is 1/160th inches (1.59 mm) thick. Of course, this value is exemplary and the door body 42 may have other thickness values as well. Moreover, the width and height of the traffic door 40 may be specified by the particular application of the traffic door 40. In one embodiment, for example, the door body 42 may have a predetermined width and height as provided by standard traffic door offerings in the industry. By way of example, typical standard traffic door dimensions include 36 inches by 84 inches (91.44 cm×213.36 cm) and 36 inches by 96 inches (91.44 cm×243.84 cm). The width and height of the door body 42, however, are not limited to standard sizes and may have a wide range of non-standard sizes as well.

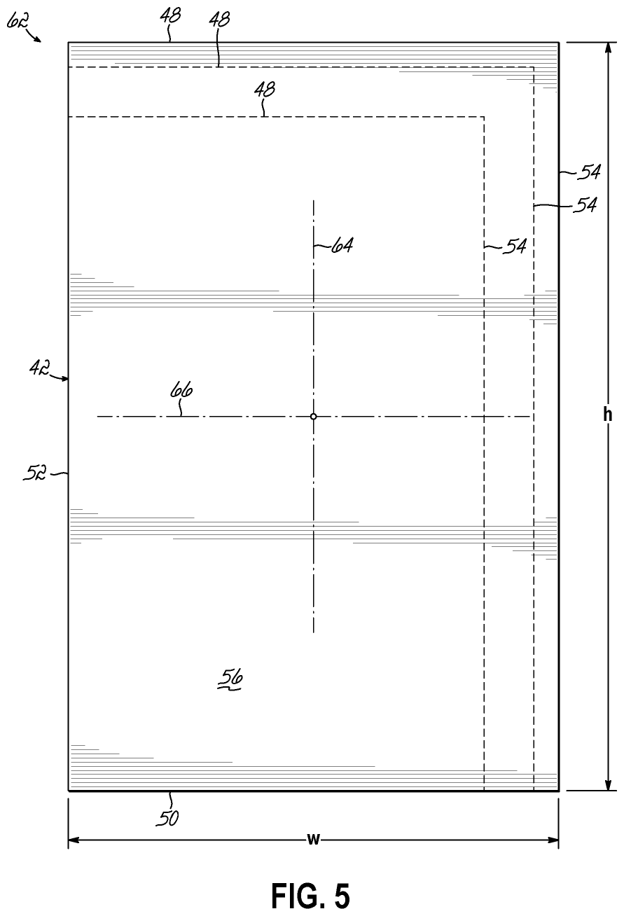

In one aspect of the present disclosure, the door body 42 may be substantially uniform in its construction in all three dimensions (i.e., in the height, width, and thickness directions). This allows door bodies 42 having a wide range of sizes to be formed from a single material blank, such as a uniformly thick sheet or slab of material (e.g., metal or plastic) of a certain, predetermined size. FIG. 5, for example, illustrates a material blank 62 used to form door body 42 of traffic door 40 in an exemplary embodiment. The material blank 62 includes a centroid defining a longitudinal central axis 64 and a transverse central axis 66. In an exemplary embodiment, the material blank 62 is generally symmetric about both the longitudinal central axis 64 and the transverse central axis 66. The material blank 62 may have the desired thickness (not shown), such as 1/16th inches (1.59 mm), and be formed of the desired material, such as aluminum. In one embodiment, the width and height of the material blank 62 may generally correspond to the width and height of the most common size of traffic door in the industry. In this way, when manufacturing the most common traffic door, minimal processing steps must be taken on the material blank 62 to form the door body 42 to the desired size.

However, for other standard traffic doors or for non-standard traffic doors having a width or height less than or equal to that of the material blank 62, other processing steps (e.g., cutting or grinding) may be taken to size the material blank 62 to the desired dimensions of the traffic door. The uniformity of the material blank 62 allows size adjustments to be performed on a single longitudinal edge or a single transverse edge of the material blank 62 (shown in phantom in FIG. 5) and result in a door body 42 of the desired size. In this way, a manufacturer needs to maintain only a single (or alternatively relatively few) material blank sizes in inventory to service most, if not all, of the orders that are likely to be received for traffic doors. This results in a very efficient usage of warehouse space for storing the materials needed for producing traffic doors. Additionally, or alternatively, a manufacturer may maintain an inventory of oversized material blanks 62 that cover nearly all (e.g., 90% and higher) height and width combinations seen in the traffic door industry. Although this approach may generate some additional waste during sizing of the material blank, the material blanks 62 are readily available to the manufacturer and the traffic doors may be made and delivered to a customer in a timely fashion and without delay. By way of example, in an exemplary embodiment, material blanks 62 may be 48 inches by 84 inches (121.92 cm×213.36 cm) or 48 inches by 96 inches (121.92 cm×243.84 cm). Other sizes are also possible.

In accordance with an aspect of the present disclosure, and as illustrated in FIG. 4, the traffic door 40 includes an edge trim 46 coupled to at least a portion of one or more edges of the door body 42. In one aspect of the disclosure, and as discussed above, the traffic door 40 may have a multi-part construction wherein the edge trim 46 is configured to be discrete and separate from the door body 42 and must be coupled to the door body 42 during manufacture of the traffic door 40. This is unlike the conventional traffic doors 10 described above, where the edge profile 28 is formed by bending the material adjacent the edges 18, 20 of the door body 12 to provide a one-piece or monolithic construction.

The purpose of the edge trim 46 is at least two-fold. First, the edge trim 46 is configured to cover or shield the sharp, unfinished edge of the door body 42, thereby improving the safety of operators and other users of the traffic door 40. To this end, the edge trim 46 is configured to provide an exposed blunted edge profile 72 having the sharp, unfinished edge of the door body 42 embedded within the edge trim 46. Additionally, any edges of the edge trim 46 itself are configured to be located inwardly along the door body 42 and spaced away from the sharp, unfinished edge of the door body 42. Second, the edge trim 46 is configured to provide increased mass and impact absorption adjacent the edge of the door body 42 to which the edge trim 46 is attached. This aids the traffic door 40 in accommodating repeated impacts while eliminating or minimizing deformations in the traffic door 40 in the edge region of the door 40, where impacts may be significant. Moreover, the added weight along one or more edges of the door body 42, especially along the leading edge 54, may provide a more solid feel to the traffic door 40 and aid in its operation. Specifically, the added weight of the edge trim 46 acting along a leading edge 54 of the traffic door 40 (e.g., along a moment arm) provides a torque which helps the traffic door 40 to return to a closed position from an open position.

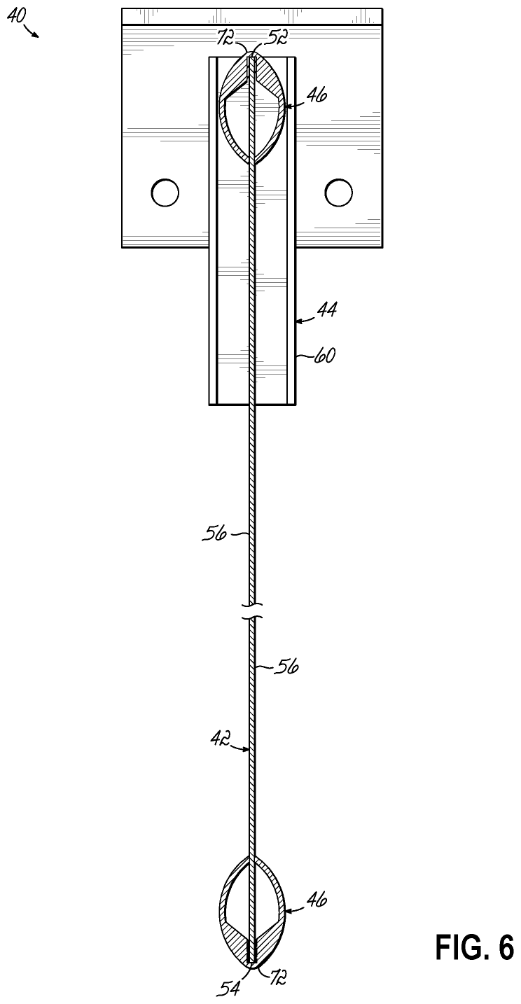

In one embodiment, the edge trim 46 may be positioned on at least a portion of the leading edge 54 of the door body 42. Because the majority of interactions with the traffic door 40 will be along the leading edge 54, it may be unnecessary to include edge trim 46 on the trailing edge 52. However, in another and preferred embodiment, the edge trim 46 may be positioned on at least a portion of the leading edge 54 and the trailing edge 52 of the door body 42. FIG. 6, for example, illustrates a cross-sectional view of the traffic door 40 illustrated in FIG. 4. In this figure, both the leading edge 54 and the trailing edge 52 of the door body 42 includes an edge trim 46 along at least a portion of these edges 52, 54. Although not shown, in a further embodiment, the edge trim 46 may alternatively or additionally be positioned on at least a portion of the upper edge 48 and/or the lower edge 50 of the door body 42. Thus, aspects of the disclosure are not limited to the edge face trim being positioned on a particular edge of the door body.

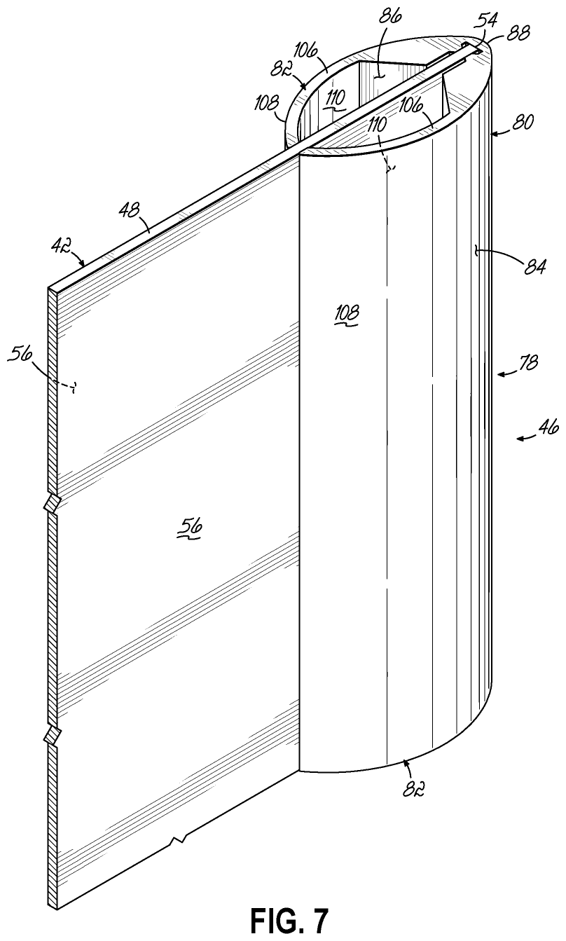

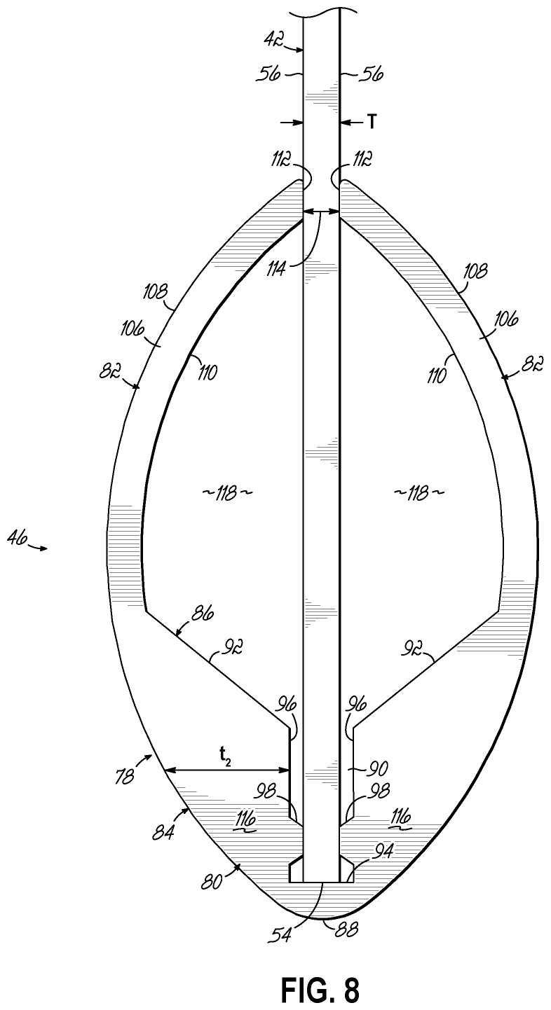

FIGS. 7 and 8 illustrate an exemplary embodiment of the edge trim 46 in accordance with the present disclosure coupled to a leading edge 54 of a door body 42. While the description of the edge trim 46 is in reference to the leading edge 54 of the door body 42, it should be understood that a similar description applies when the edge trim 46 is coupled to other edges of the door body 42. In this embodiment, the edge trim 46 includes a generally tubular, elongate trim body 78 having a central spine 80 and a pair of arms 82 extending from the spine 80. As illustrated in FIG. 8, the spine 80 may be generally U-shaped defining a generally smooth and arcuate outer surface 84 and an inner surface 86. The outer surface 84 includes a blunted apex 88, which represents the now exposed edge or outer extent of the traffic door 40. The inner surface 86 of the spine 80 includes a central cavity 90 and a pair of guide walls 92 on either side of the central cavity 90. The central cavity 90 is configured to receive the sharp, unfinished edge (e.g., the leading edge 54) of the door body 42 and embed that edge within the edge trim 46. The guide walls 92 are angled or chamfered in such a way as to guide the edge 54 of the door body 42 towards and into the central cavity 90 during assembly (discussed below). In one embodiment, the central cavity 90 may be generally rectangular and include a base wall 94 and a pair of generally parallel side walls 96 extending from the base wall 94 and intersecting the guide walls 92. The central cavity 90 is open along an end opposite the base wall 94 and adjacent the guide walls 92 so as to receive the edge 54 of the door body 42 therein.

The width of the central cavity 90 (e.g., the spacing between the side walls 96) is configured so as to closely receive the edge 54 of the door body 42 therein such that the edge 54 may be positioned in abutting engagement or near abutting engagement with the base wall 94 of the central cavity 90. For example, the width of the central cavity 90 may be slightly larger (e.g., 2-10%) than the thickness of the door body 42. In one aspect of the disclosure, the edge trim 46 is configured to be secured to the door body 42 through a friction fit. In other words, there are no screws, bolts, rivets or other separate fasteners for securing the edge trim 46 to the door body 42. This not only reduces the number of parts in manufacturing the traffic door, but this also improves the overall aesthetic appearance of the traffic door 40. The length of the cavity 90 may be selected to provide sufficient contact area for creating a friction fit that will hold the edge trim 46 to the door body 42. For example, the length of the cavity 90 may be between about 0.15 inches (3.8 mm) and about 0.35 inches (8.9 mm). Other lengths are, however, also possible.

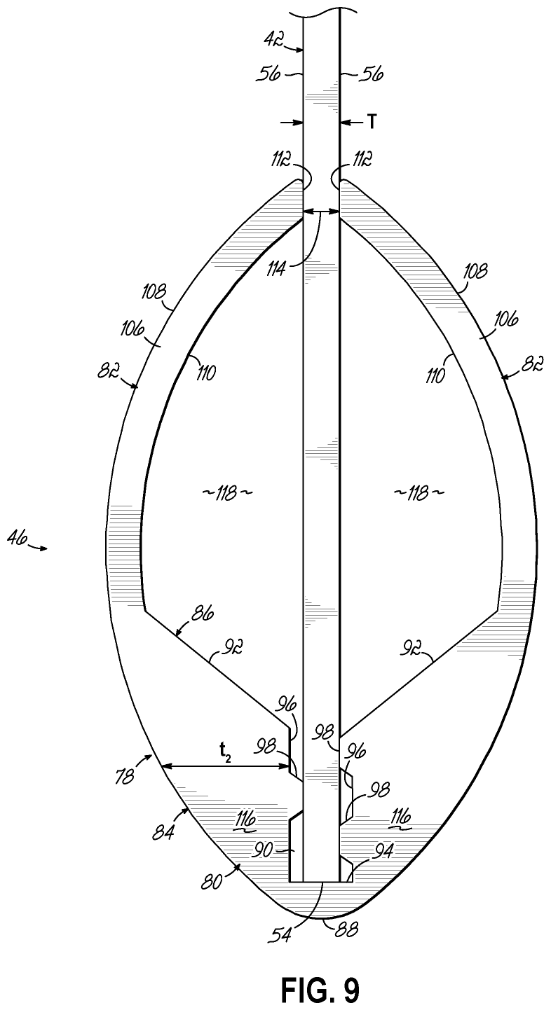

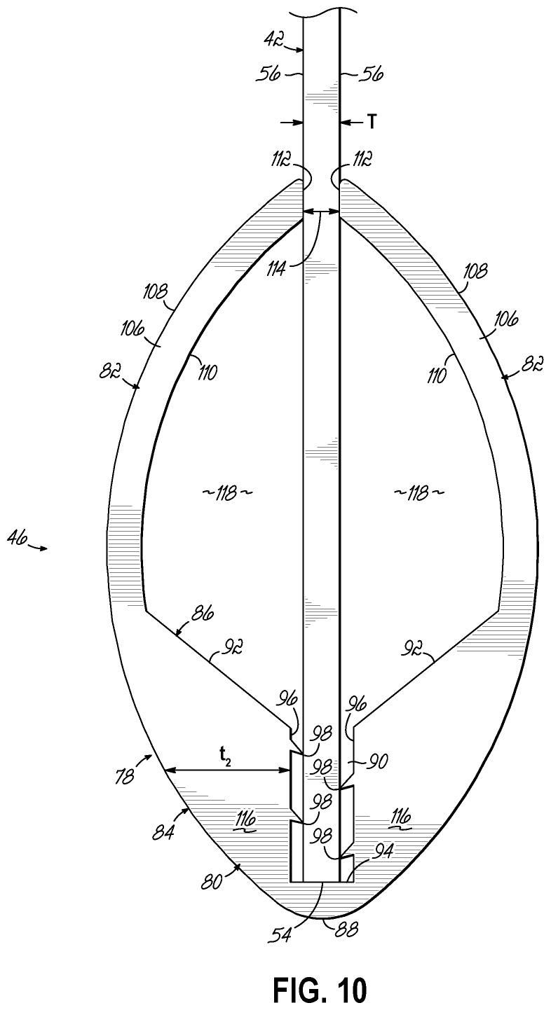

To facilitate a friction fit of the door body 42 within the cavity 90, the side walls 96 of the cavity 90 may include one or more friction-enhancing elements. In an exemplary embodiment, each of the side walls 96 of the cavity 90 may include one or more teeth 98 that facilitate frictional engagement between the edge trim 46 and the door body 42. In this regard, the teeth 98 are configured to tightly receive (such as via slight plastic or elastic deformation of the material of the teeth 98) the door body 42 and frictionally hold the door body 42 within the cavity 90. For example, each side wall 96 may include one, two or three teeth 98 along its length from the base wall 94 toward the guide walls 92. Additional teeth 98 on each side wall 96 may also be possible. The number of teeth 98 on one side wall 96 of the cavity 90 may be the same or may be different from the number of teeth 98 on the opposing side wall 96. In one embodiment, the teeth 98 on the opposing side walls 96 may be generally aligned with each other (i.e., same location along the length of the side wall 96). This configuration may, for example, increase the frictional force at the aligned teeth. In another embodiment, however, the teeth 98 on opposing side walls 96 may be offset from each other along the length of the side wall 96. This configuration may, for example, result in a more uniform frictional force along the length of the cavity 90. FIG. 8 illustrates an embodiment where each side wall 96 has one tooth, and the teeth 98 are generally aligned with each other across the cavity 90. FIG. 9 illustrates an alternative embodiment where one side wall has one tooth 98 and the opposing side wall has two teeth 98, and the teeth 98 are offset from each other across the cavity 90. FIG. 10 illustrates an embodiment where each side wall 96 has two teeth 98, and the teeth 98 are offset from each other across the cavity 90. Other arrangements of teeth 98 may also be possible and remain within the scope of the present disclosure.

The teeth 98 on the side walls 96 of the cavity 90 may have a wide variety of shapes. By way of example, in one embodiment, the teeth 98 may be generally conical with a truncated tip (e.g., flat tip). Such teeth 98 are illustrated in FIGS. 8 and 9, for example. In an alternative embodiment, the teeth 98 may be generally triangular in shape and terminate at a relative sharp tip. Such teeth 98 are illustrated in FIG. 10, for example. The shape of the teeth 98 is not limited to the illustrated shapes and other shapes are also possible that facilitate frictional engagement with the door body 42. In one embodiment, the teeth 98 may project substantially perpendicular from the side walls 96 of the cavity 90 as shown in FIGS. 8 and 9. Alternatively, however, the teeth 98 may point generally toward the base wall 94 of the cavity 90. The angling of the teeth 98 in this manner may allow the door body 42 to be inserted into the cavity 90 with a relatively low insertion force but result in a relatively high frictional force (e.g., removal force) that maintains the position of the edge trim 46 on the edge 54 of the door body 42. In one embodiment, the teeth 98 may extend continuously for the full length or substantially the full length of the edge trim 46. Alternatively, the teeth 98 may include one or more discrete teeth sections spaced apart at regular or irregular intervals along the length of the edge trim 46.

Turning now to the arms 82 of the edge trim 46, in an exemplary embodiment, the arms 82 project from the opposed ends of the spine 80 and include an elongate body 106 having an outer surface 108 and an inner surface 110. A proximal end of the arms 82 is coupled to the opposed ends of the spine 80 opposite the apex 88, and the distal ends of the arms 82 define trim edges 112. The inner surface 110 of the arms 82 intersects the guide walls 92 of the spine 80 and the outer surface 108 of the arms 82 intersect the outer surface 84 of the spine 80 at their proximal ends. In an exemplary embodiment, the arms 82 are generally arcuate in shape such that the arms 82 converge toward each other in a direction away from the spine 80. In one embodiment, the transition from the outer surface 84 of the spine 80 to the outer surface 108 of the arms 82 may be smooth and continuous. For example, the radius of curvature of the outer surfaces 84, 108 of the spine 80 and arms 82, respectively, may be such that the edge trim 46 has an overall oblong or oval (outer) cross-sectional shape (see FIGS. 8-10). Such a cross-sectional shape is generally devoid of sharp edges along the exposed outer surface of the edge trim 46. In an exemplary embodiment, but for the trim edges 112, the “sharpest” exposed portion of the edge trim 46 may be at the apex 88 of the spine 80. However, the apex 88 of the spine 80 is configured to be arcuate and relatively blunt, e.g., with a radius of curvature well above that which would pose a hazard to operators coming into contact with the apex 88 of the edge trim 46 during use of the traffic door 40. By way of example, the radius of curvature of the apex 88 may be above about 0.15 inches (3.8 mm). Alternatively, the edge trim 46 may take on other shapes that are more or less round than oblong or oval shape. The arms 82 extend away from the spine 80, and away from the edge 54 of the door body 42 embedded within the spine 80, so as to generally overlie the faces 56 of door body 42 and locate the trim edges 112 inwardly of and away from the edge 54 of the door body 42. By way of example, when the door body 42 is seated within the edge trim 46, the trim edges 112 of the arms 82 may be between about 1.0 inch (2.54 cm) and 1.5 inches (3.81 cm) away from the edge 54 of the door body 42.

The trim edges 112 of the arms 82 define a gap 114 therebetween so as to snugly receive the door body 42 therethrough. In one embodiment, for example, the gap 114 may be equal to or just slightly less than (e.g., by less than about 5%) the thickness T of the door body 42. In this way, the arms 82 may slightly spread or flex apart during insertion of the door body 42 through the gap 114 of the edge trim 46. Accordingly, this may further increase the frictional force that secures the edge trim 46 to the door body 42. Moreover, the arcuate shape of the arms 82 further orients the trim edges 112 so as to substantially confront the respective faces 56 of the door body 42. Thus, according to this configuration, the trim edges 112 are spaced inwardly and away from the outer extent of the traffic door 40 and are arranged to confront and engage with the faces 56 of the door body 42 (see FIGS. 8-10). In this way, the sharp, unfinished edge 54 of the door body 42 is not only covered and shielded from operators of the traffic door 40, but the trim edges 112 are also spaced away from the edge 54 region of the traffic door 40, where impacts may be high, and oriented in such a manner as to eliminate or minimize potential exposure of the trim edges 112 to operators and other uses of the traffic door 40.

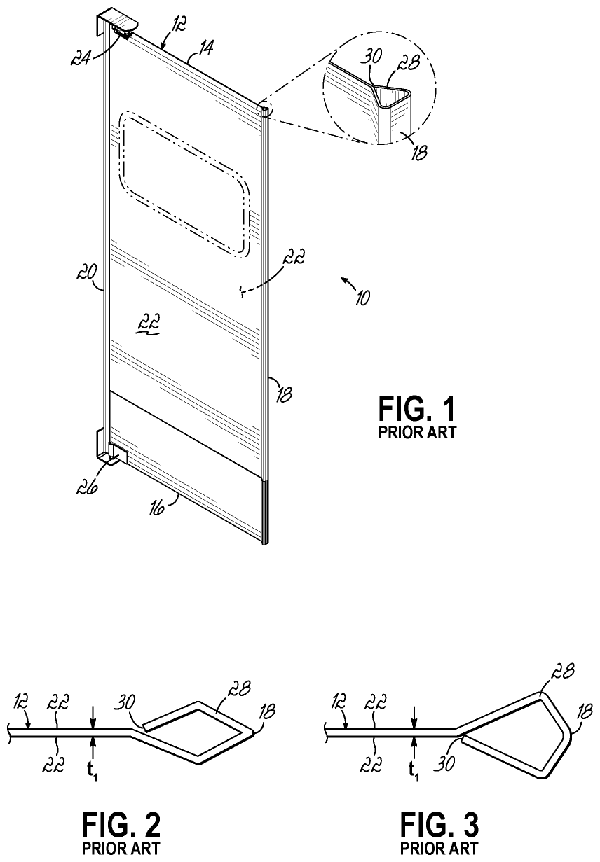

As discussed above in reference to FIGS. 1-3, the edge profile 28 of the traffic door 10 may be formed by bending the material of the door body 12 adjacent the selected edges, such as leading and trailing edges 18, 20. Thus, the thickness ti of the material that forms the edge profile 28 (i.e., the thickness of the sheet that forms the door body 12; see FIGS. 2 and 3) is relatively constant and relatively thin. Thus, although the material of the door body 12 is bent into a particular configuration, such as the delta-shape or the diamond-shape, the strength of the edge profile 28 remains low due to the relatively thin wall thickness t₁, (e.g., see FIG. 3) of the material that forms the edge profile 28. It is believed that the lack of strength, due to thin wall thickness t₁ of the edge profile 28, results in the edge profile 28 being susceptible to deformation from repeated impacts on the traffic door 10 during use. It is further believed that these deformations, in turn, potentially expose the sharp, unfinished edge 30 of the door body 12, thereby increasing safety concerns for operators and other users of the traffic door 10.

In accordance with an aspect of the present disclosure, to avoid such a scenario, the edge trim 46 provides a wall thickness t₂ adjacent the leading edge 54 of the door body 42 that adds structural rigidity and is sufficient to withstand the anticipated impacts on the traffic door 40 during use. The wall thickness t₂ of the edge trim 46 may be measured in a direction generally perpendicular to the faces 56 of the door body 42 (when inserted therein) and between the inner and outer surfaces 86, 84 of the spine 80. In accordance with an aspect of the disclosure, the wall thickness t₂ of the spine 80 is greater than the thickness T of the door body 42 for at least 50% of the length of the cavity 90, more preferably at least 75% of the length of the cavity 90, and even more preferably at least 90% of the length of the cavity 90. In one embodiment, for example, the wall thickness t₂ of the spine 80 may be greater than the thickness T of the door body 42 for 100% of the length of the cavity 90 (i.e., from the base wall 94 to the open end of the cavity 90). In one embodiment, the wall thickness t₂ of the spine 80 may vary along the length of the cavity 90. For example, the wall thickness t₂ may be a minimum adjacent the base wall 94 and increase in thickness in a direction away from the base wall 94 toward the open end of the cavity 90. The maximum wall thickness may occur, for example, at the open end of the cavity 90, at which point the wall thickness t₂ of the spine 80 may be between about two to five times the thickness T of the door body 42. In alternative embodiments, the maximum wall thickness t₂ of the spine 80 may occur at other locations along the length of the cavity 90. In any event, the thickened solid construction of the spine 80 in the region of the leading edge 54 of the door body 42 operates as reinforcing regions 116 to minimize or eliminate deformations of the edge trim 46 due to repeated impacts on the traffic door 40 during use. Thus, the chances of the trim edges 112 coming away from the respective faces 56 of the door body 42 and becoming exposed during the operational life of the traffic door 40 is relatively low. Accordingly, the safety of operators and other users of the traffic door 40 is improved.

While having an edge trim with a complete solid construction from the gap between the arms to the apex of the spine (i.e., a solid wall thickness from the faces of the door body to the outer surface of the edge trim along the full length of the door body received in the edge trim) may provide the greatest strength and impact resistance to the edge trim 46, such a complete solid construction would be heavy and costly in terms of material usage. Moreover, the strength provided by such a solid construction may also far exceed what is required to eliminate or minimize deformations of the edge trim 46 during usage (i.e., overdesigned). To reduce the weight and minimize material usage, the solid construction of the edge trim 46 may be concentrated near the edge 54 of the door body 42 and interior void regions 118 may be provided away from the edge 54 of the door body 42. Thus, for example, the inner surface 110 of the arms 82 and the guide walls 92 may be laterally spaced from the faces 56 of the door body 42 to define the void regions 118. Thus, the cross-sectional profile of the trim edge 46 as illustrated, for example, in FIGS. 8-10, is configured as a balance between strength, weight, material usage, cost, and perhaps other factors.

In an exemplary embodiment, the edge trim 46 may be formed from a metal, such as aluminum, stainless steel, or other suitable metals. Alternatively, the edge trim 46 may be formed from a suitable plastic material, such as acrylonitrile butadiene styrene (ABS), fiber reinforced polymers (FRP), polyvinyl chloride (PVC), or other plastics. Due to a consistent cross-sectional profile along the length of the edge trim 46, in an exemplary embodiment, the edge trim 46 may be formed through an extrusion process where a billet of material (e.g., aluminum) is heated and forced to flow through a die having the desired cross-sectional profile of the edge trim 46. The extrusion process is a relatively quick, efficient, and low-cost manufacturing technique capable of forming reliable and consistent parts of relatively high-tolerance dimensions (e.g., cavity size, teeth size, apex radius of curvature, gap dimension, etc.). The extrusion process also allows the edge trim 46 to be of high strength, thereby increasing the resistance to deformations due to repeated impacts on the edge trim 46 during the operational lifetime of the traffic door 40.

Furthermore, the extrusion process allows an elongate strip of edge trim 46 to be produced having a wide variety of lengths. In one embodiment, the length of the elongate strip of edge trim 46 may be predetermined and selected to correspond to the length of the most common traffic door in the industry. Alternatively, the length of the elongate strip of edge trim 46 may be oversized so as to accommodate nearly all (e.g., 90% or higher) of traffic door heights seen in the traffic door industry. During manufacturing of the traffic door 40, if necessary, the edge trim strips may be cut to the desired length depending on the particular size of the door body 42 to which the edge trim 46 is being attached. This allows a manufacturer to stock a single or just a few lengths of edge trim strips in inventory, which is desirable from a cost and space-savings standpoint. By way of example and without limitation, the length of the strips of edge trim 46 may be 7 feet (213.36 cm), 8 feet (243.84 cm) or 10 feet (304.8 cm). Although the above describes an extrusion process for making the edge trim 46, this is merely exemplary and those of ordinary skill in the art will recognize that the edge trim 46 may be made through other processes, including various molding and casting processes.

To manufacture the traffic door 40 in accordance with the present disclosure, the manufacturer will remove a material blank 62 from inventory. As mentioned above, the manufacturer may stock a single or just a few sizes of material blanks 62. If the material blank 62 is of the appropriate height and width (and thickness) of the desired traffic door body 42, then the blank 62 may proceed to the next processing steps. However, if the material blank 62 has a size that is different than the desired dimensions of the door body 42, then the material blank 62 may be cut to size, such as by removing material from a longitudinal edge (for width adjustments) and/or a transverse edge (for length adjustments) of the material blank 62. This may be achieved by various cutting operations known to those of ordinary skill in the art. After sizing the material blank 62 to correspond to the desired size of the door body 42, the door body 42 may be processed to include the hinge mechanism 44, window 38 (if any), and any other features of the traffic door 40, such as bumpers, for example. These processing steps are also generally known to those of ordinary skill in the art and will not be discussed in further detail herein.

Subsequently, the edge trim 46 may be coupled to at least a portion of one or more edges of the door body 42. In one embodiment and as illustrated in FIG. 4, edge trim 46 may be coupled to both the leading edge 54 and the trailing edge 52 of the door body 42. Starting with the leading edge 54, the manufacturer may obtain a strip of edge trim 46 from inventory. As mentioned above, the manufacturer may stock a single or just a few different lengths of edge trim strips. If the strip of edge trim 46 is of the desired length of the leading edge 54 of the traffic door body 42 (that is to be covered by the edge trim 46), then the strip of edge trim 46 may be immediately positioned over and aligned with the leading edge 54 of the door body 42 such that the arms 82 of the edge trim 46 confront the leading edge 54. If, however, the strip of edge trim 46 has a length that is different than the desired length of the leading edge 54, then the strip of edge trim 46 may be cut to size, via various cutting operations known to those of ordinary skill in the art. The strip may then be positioned over and aligned with the leading edge 54 of the door body 42 such that the arms 82 of the edge trim 46 confront the leading edge 54. The strip of edge trim 46 may then be pressed onto the leading edge 54 by guiding the leading edge 54 through the gap 114 between the arms 82 and toward the cavity 90 in the spine 80. Should the strip of edge trim 46 be out of alignment or become misaligned during the process, the leading edge 54 will contact one of the guide walls 92 and automatically readjust the alignment such that the leading edge 54 ultimately arrives at the opening to the cavity 90.

With further pressing, the leading edge 54 of the door body 42 will enter the cavity 90 and engage with the teeth 98 along the side walls 96 of the cavity 90. An increased pressing force may be imposed to permit the leading edge 54 to move past the teeth 98 and engage or nearly engage with the base wall 94 of the cavity 90, thereby seating the leading edge 54 of the door body 42 within the edge trim 46. The engagement of the teeth 98 with the faces 56 of the door body 42 and the engagement of the trim edges 112 with the faces 56 of the door body 42 provide a frictional engagement or fit that secures the edge trim 46 to the door body 42. Moreover, due to the shape and construction of the edge trim 46, forces imparted by operators or material handling equipment on the edge trim 46 serve to continually reinforce the fit between the door body 42 and the teeth 98. In accordance with an aspect of the disclosure, the amount of force required to overcome the friction fit and remove the edge trim 46 from the leading edge 54 of the door body 42 is greater, and perhaps significantly greater, than any expected force imposed on the edge trim 46 during use of the traffic door 40. Thus, it is expected that the edge trim 46 will not become loosened from the leading edge 54 of the door body 42 during the operational lifetime of the traffic door 40.

With the edge trim 46 secured to the leading edge 54 of the door body 42, the manufacturer may then attach edge trim 46 to the trailing edge 52 of the door body 42. In this regard, a similar process as described above for the leading edge 54 may be used to attach the edge trim 46 to the trailing edge 52. That process may similarly be used if edge trim 46 is attached to other edges of the door body 42, such as along the upper or lower edges 48, 50. The pressing of the edge trim 46 onto the edge or edges of the door body 42 may be achieved manually or by using automated equipment. In an exemplary embodiment, for example, the force for pressing the edge trim 46 onto the door body 42 may be a percussive force imposed by a technician using a suitable hand tool, such as a rubber mallet or other type of hammer. Alternatively, a pressing apparatus using various hydraulic, pneumatic or other actuators may apply the pressing force for engaging the edge trim 46 with the door body 42. Other tools and processes for attaching the edge trim 46 to the door body 42 may also be possible and are not limited to the those described herein.

In an exemplary embodiment, and as illustrated in FIG. 4, edge trim 46 may be attached to the leading edge 54 of the door body 42 so as to span substantially the full height (e.g., greater than 90%) of the door body 42 from the lower edge 50 to the upper edge 48. Aspects of the disclosure, however, are not limited to such an embodiment. In alternative embodiments, for example, the edge trim 46 may span 50% or more of the height of the door body 42 along the leading edge 54, and preferably 75% or more of the height of the door body 42 along the leading edge 54. In a similar manner, edge trim 46 may be attached to the trailing edge 52 of the door body 42 so as to span substantially the full height (e.g., greater than 90%) of the door body 42 from the lower edge 50 to the upper edge 48 (at least the portion not already occupied by the hinge mechanism 44). However, in alternative embodiments, the edge trim 46 may span 50% or more of the height of the door body 42 along the trailing edge 52, and preferably 75% or more of the height of the door body 42 along the trailing edge 52. Should edge trim 46 be attached to other edges of the door body 42, such as along the upper and lower edges 48, 50, the edge trim 46 may similarly span those edges as well.

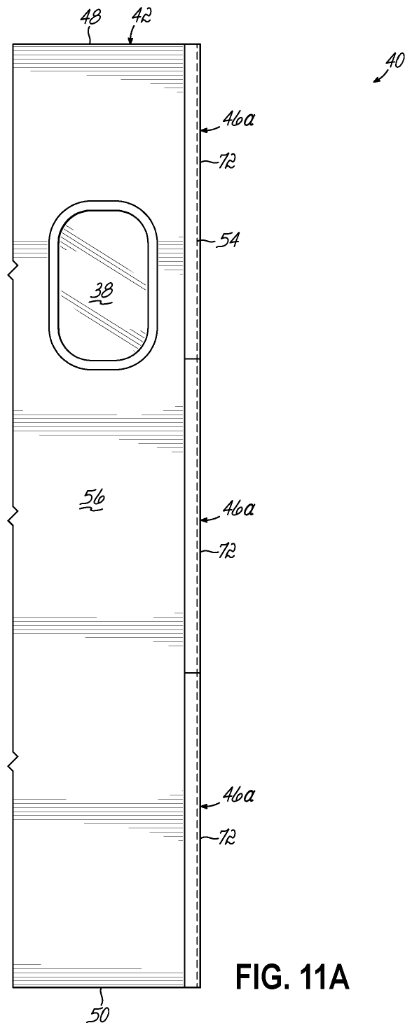

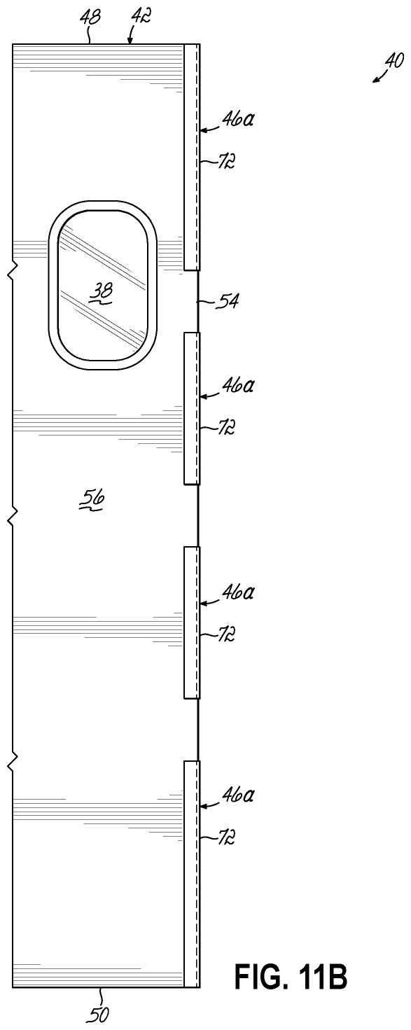

In an exemplary embodiment, the edge trim 46 along the edges of the door body 42, such as the trailing and leading edges 52, 54, may consist of a single continuous length of edge trim 46. FIG. 4, for example, illustrates such an embodiment. Aspects of the disclosure, however, are not so limited. By way of example, the edge trim 46 along an edge of the door body 42 may include a plurality of discrete edge trim sections. FIG. 11A, for example, illustrates a traffic door 40 having edge trim 46 along the leading edge 54 of the door body 42 configured as a plurality of edge trim sections 46a. In this embodiment, the edge trim sections 46a may be attached to the door body 42 in abutting end-to-end fashion. It should be recognized that while edge trim 46 is only shown on the leading edge 54 of the traffic door 40 in FIG. 11A, edge trim 46 may be included along other edges of the door body 42 and have an arrangement similar to that shown at the leading edge 54 in FIG. 11A. In an alternative embodiment, and as illustrated in FIG. 11B, the edge trim sections 46a may be attached to the door body 42 in non-abutting end-to-end fashion (i.e., spaces between adjacent edge trim sections 46a ). It should similarly be recognized that while edge trim 46 is only shown on the leading edge 54 of the traffic door 40 in FIG. 11B, edge trim 46 may be included along other edges of the door body 42 and have an arrangement similar to that shown at the leading edge 54 in FIG. 11B. Accordingly, it should be recognized that edge trim 46 may be attached to one or more edges of the door body 42 in a wide variety of arrangements and configurations and is not limited to that shown and described herein.

The traffic door having edge trim as disclosed herein provides a number of benefits over current traffic doors. As noted above, because of the edge trim covers the sharp, unfinished edge of the door body and because the edge trim is designed to be more resistant to deformations during the use of the traffic door, the likelihood of the sharp edge of the door body becoming exposed at some point during the operational life of the traffic door is low, and significantly lower compared to current traffic doors. Accordingly, the safety of operators and other uses of the traffic door is improved. Additionally, the edge trim is configured to be secured to the door body through a friction fit. This avoids the use of fasteners, such as screws, bolts or rivets, and provides a more aesthetically pleasing traffic door with fewer parts and simplified assembly.

Furthermore, forming the edge trim separate from the door body provides a number of efficiencies that are beneficial in the manufacturing of traffic doors. For example, by separating the edge trim from the door body, manufacturers need to stock one or relatively few different sizes of material blanks used to form the door bodies, and one or relatively few lengths of edge trim strips. This, in turn, provides lower warehousing costs for the materials used to make the traffic doors. Additionally, separating the edge trim from the door body allows non-traditional traffic doors to be manufactured without the high cost and time delays of custom manufacturing.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A traffic door, comprising:
a door body having at least one edge and opposed faces; and
an edge trim including an inner surface and an outer surface and attached to the door body so as to cover at least a portion of the at least one edge,
wherein the inner surface of the edge trim includes a cavity that receives the at least a portion of the at least one edge therein, and wherein the edge trim is secured to the door body through a friction fit between the cavity and the door body.

2. The traffic door of claim 1, wherein the door body is generally rectangular and includes a leading edge and a trailing edge, and wherein the edge trim is attached to the door body so as to cover at least a portion of the leading edge.

3. The traffic door of claim 1, wherein the edge trim is attached to the door body so as to cover at least a portion of the trailing edge.

4. The traffic door of claim 1, wherein the cavity includes one or more teeth for facilitating the friction fit between the cavity and the door body.

5. The traffic door of claim 4, wherein the cavity is generally rectangular and further comprises:
a base wall confronting the at least one edge of the door body; and
a pair of opposed side walls extending from the base wall and confronting the opposed faces of the door body,
wherein each of the side walls includes one or more teeth extending from the side wall.

6. The traffic door of claim 5, wherein the one or more teeth on the opposed side walls are aligned with or offset from each other along the length of the cavity.

7. The traffic door of claim 1, wherein the edge trim includes reinforcement regions adjacent the cavity.

8. The traffic door of claim 7, wherein the door body has a thickness, wherein the edge trim has a wall thickness along the cavity, and wherein the wall thickness of the edge trim is greater than the thickness of the door body for at least 50% of the length of the cavity.

9. The traffic door of claim 8, wherein the wall thickness of the edge trim is greater than the thickness of the door body for at least 75% of the length of the cavity.

10. The traffic door of claim 8, wherein the wall thickness of the edge trim is greater than the thickness of the door body for at least 90% of the length of the cavity.

11. The traffic door of claim 7, wherein the edge trim includes void regions away from the cavity.

12. The traffic door of claim 1, wherein the edge trim includes a generally oval cross-sectional profile.

13. The traffic door of claim 1, wherein the edge trim further comprises:
a spine having an inner surface and an outer surface, the inner surface of the spine including the cavity; and
a pair of arms extending from opposed sides of the spine and overlying a respective face of the door body.

14. The traffic door of claim 13, wherein each of the arms is arcuate and the arms converge toward each other in a direction away from the spine, and wherein a distal end of the arms defines a gap that receives the door body therebetween.

15. The traffic door of claim 13, wherein each of the arms includes a trim edge at a distal end thereof, and wherein the trim edges engage with a respective face of the door body and are spaced from the at least one edge.

16. A method of making a traffic door, comprising:
providing a door body having at least one edge and opposed faces;
providing an edge trim including an inner surface and an outer surface, wherein the inner surface of the edge trim includes a cavity configured to receive at least a portion of the at least one edge therein;
positioning the edge trim relative to the at least one edge of the door body such that the inner surface of the edge trim confronts the at least one edge of the door body; and
pressing the edge trim toward the door body so that the at least one edge of the door body is inserted into the cavity to secure the edge trim to the door body through a friction fit between the cavity and the door body.

17. The method of claim 16, wherein providing the door body further comprises:
providing a material blank of a predetermined size; and
cutting the material blank to provide the door body with a desired size.

18. The method of claim 16, wherein providing the edge trim further comprises forming the edge trim through an extrusion process.

19. The method of claim 16, wherein providing the edge trim further comprises:
providing an elongate strip of edge trim having a predetermined length; and
cutting the elongate strip to provide the edge trim with a desired length.

20. The method of claim 16, wherein pressing the edge trim toward the door body further comprises engaging the door body with one or more teeth positioned within the cavity to provide the friction fit between the cavity and the door body.

21. The method of claim 16, wherein pressing the edge trim toward the door body is performed manually or automatically.

22. The method of claim 16, wherein the edge trim further comprises a spine having an inner surface and an outer surface, the inner surface of the spine including the cavity, and a pair of arms extending from opposed sides of the spine and overlying a respective face of the door body, and wherein pressing the edge trim toward the door body further comprises inserting the at least one edge of the door body through a gap defined between a distal end of the arms of the edge trim.

23. The method of claim 22, further comprising forming a friction fit between the distal end of the arms and the opposed faces of the door body.

24. The method of claim 16, wherein providing the edge trim further comprises forming reinforcing regions in the edge trim adjacent the cavity and forming void regions in the edge trim away from the cavity.

25. The method of claim 16, wherein the door body includes a leading edge and a trailing edge, and wherein positioning the edge trim relative to the at least one edge of the door body further comprises positioning the edge trim relative to at least one of the leading or trailing edges of the door body.

26. An edge trim for attachment to a door body of a traffic door, the door body having an edge and opposed faces, the edge trim configured to cover at least a portion of the edge of the door body, the edge trim comprising:
a spine having an inner surface and an outer surface, the inner surface including a cavity configured to receive the edge of the door body therein; and
a pair of arms extending from opposed sides of the spine and configured to overlie a respective face of the door body,
wherein the cavity includes a plurality of friction-enhancing elements to effectuate a fiction fit between the edge trim and the door body when coupled together.

27. The edge trim of claim 26, wherein the cavity is generally rectangular and further comprises:
a base wall configured to confront the edge of the door body; and
a pair of opposed side walls extending from the base wall and configured to confront the opposed faces of the door body,
wherein each of the side walls includes one or more teeth extending from the side wall.

28. The edge trim of claim 26, wherein the edge trim includes reinforcement regions adjacent the cavity.

29. The edge trim of claim 26, wherein the edge trim includes void regions away from the cavity.

30. The edge trim of claim 26, wherein the edge trim includes a generally oval cross-sectional profile.

31. The edge trim of claim 26, wherein each of the arms is arcuate and the arms are configured to converge toward each other in a direction away from the spine, and wherein a distal end of the arms defines a gap configured to receive the door body therebetween.
